(19) United States
(12) Patent Application Publication
(10) Pub. No.: US 2007/0103739 A1
(43) Pub. Date: May 10, 2007

(54) Apparatus and methods for remote viewing and scanning of microfilm

(76) Inventors: Thomas P. Anderson JR., Lake Forest, IL (US); Daniel J. Donaldson, Ramcha, CA (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/270,298

(22) Filed: Nov. 9, 2005

(51) Int. Cl. H04N 1/04

(52) U.S. Cl. 358/479; 358/487; 358/498

(57) ABSTRACT

Apparatus for remotely viewing and scanning microfilm at a first location, while controlling the viewing and scanning from a remote location, including a viewing and scanning device for generating a video feed and subsequently scanned images of the microfilm, a host computer at the first location in communication with the viewing and scanning device to receive the video feed and the scanned images, a user's computer at a remote location in communication with the host computer to receive the video feed and the scanned images from the host computer, and a virtual film movement control at the user's computer to control the movement of the microfilm at the first location. A virtual camera control at the remote location controls the camera of the viewing and scanning device.

### FIELD OF THE INVENTION

The present invention relates generally to apparatus and methods for viewing and scanning of microfilm.

More particularly, the present invention relates to improved apparatus and methods that provide for viewing and scanning of microfilm and the like from a remote location.

### BACKGROUND OF THE INVENTION

Collections and libraries of images and documents exist on microfilm in many locations throughout the world. Many documents and other images have been placed on microfilm over the past several decades. In many instances, certain documents may only be available from microfilm. The microfilm media may be in various forms including cartridges, rolls and microfiche cards. For example, documents in the typical 8 inch by 11½ inch page format are frequently stored on 16 mm cartridges. Large engineering and architectural drawings are typically stored on 35 mm media. Of course, older collections may be on microfiche cards. Existing microfilm readers typically accommodate many or all of these different microfilm formats.

Often such microfilm collections are housed at significant distances from researchers or other individuals who would like to view the content and to copy or make use of it. In addition to the distances between the microfilm and the viewers, copyright issues may exist. The cost of duplicating any microfilm collection may also be prohibitive or impractical due to the millions of images that may exist on hundreds or thousands of rolls of film or microfiche cards. Many of the same factors also make digitization of microfilm collections impractical and unduly expensive.

In addition, manual handling of microfilm by trained handlers is frequently preferred by the owners of microfilm collections. This is because there is less theft of the microfilm, there is less misfiling of the microfilm after use, unauthorized duplication can be avoided, unauthorized access or viewing can be controlled, and copyright issues can be limited. Researchers or users of microfilm content therefore must usually appear at the location of the microfilm collection in order to review it. Some owners of microfilm collections regularly make and sell copies of images upon receiving orders.

There has therefore been a longstanding need to provide and facilitate live viewing of selected portions of a microfilm library or collection from a remote location, such as of images not yet scanned from the microfilm.

A general object of the present invention is to provide means for a remote user to view and act upon selected portions or pages of microfilm.

Another object of the present invention is to provide means for a remote user to copy, store, print, email or record selected portions or pages of microfilm.

A further object of the present invention is to provide means for a remote user to view selected portions or pages of microfilm from a remotely located personal computer, laptop computer, personal digital assistant, or the like, such as via the internet.

Yet another object of the present invention is to provide means for a user to remotely control the scanning and other functions of a microfilm reader at the user's computer to view or act upon selected portions or pages of microfilm.

A still further object of the present invention is to provide a viewing mode screen and a scanning mode screen for a user at a remote location to control the scanning, printing, emailing or storing of images acquired from microfilm.

### SUMMARY OF THE INVENTION

The present invention is directed to apparatus for remotely viewing and scanning microfilm located at a first location while controlling the viewing and scanning from a remote location. The apparatus includes a viewing and scanning device for viewing and scanning microfilm at the first location, the viewing and scanning device generating streaming video to view the high resolution scanned images of the microfilm, a host computer at the first location, the host computer in communication with the viewing and scanning device to receive the video feed and scanned images, a user's computer at a remote location from the first location, the user's computer in communication with the host computer to receive the video feed and scanned images from the host computer, and a virtual film movement control at the user's computer to enable a user at the remote location to control the movement of the microfilm at the first location.

The virtual film movement control may include at least one control function selectable from the group consisting of forward film movement, fast forward film movement, reverse film movement, fast reverse film movement and stop film movement. The apparatus may also include a virtual camera control at the remote location for controlling a camera of the scanning device that generates the images. The virtual camera control may include at least one control function selectable from the group consisting of zoom in, zoom out, near focus, far focus, auto-focus, iris normal, iris open and iris closed.

Software provides the user's computer with a viewing mode screen for reviewing and selecting an image and with a scanning mode screen for acting upon a selected image. Actions that may be selected in the scanning mode screen include editing the scanned image, burning the scanned image onto a CD, sending the scanned image to a memory for storage, printing the scanned image and emailing the scanned image. Preferably, the scanning mode screen includes a tool bar with a plurality of icons. Each of the plurality of icons corresponds to a selectable action which includes editing the scanned image, burning the scanned image onto a CD, sending the scanned image to a memory for storage, printing the scanned image or emailing the scanned image.

The present invention also includes related methods performed by the above apparatus. One method of scanning microfilm at a first location while viewing and controlling the scanning from a remote location includes the steps of generating a video image of the microfilm at the first location, communicating the video image from the first location to the remote location, and providing a virtual film movement control at the remote location to enable a user at the remote location to control the movement of the microfilm at the first location. The step of providing a virtual film movement control includes one or more of the sub steps of forward film movement, fast forward film movement, reverse film movement, fast reverse film movement, and stop film movement.

Another method includes the step of providing a virtual camera control at the remote location for controlling a camera at the first location that generates the images. The step of providing a virtual camera control includes one or more of the sub steps of zoom in, zoom out, near focus, far focus, auto-focus, iris normal, iris open, and iris closed.

The methods further contemplate providing a viewing mode screen at the user's computer for reviewing and selecting an image and providing a scanning mode screen for acting upon a selected image. The step of acting upon a selected image includes one or more of the sub steps of editing the scanned image, burning the scanned image onto a CD, sending the scanned image to a memory for storage, printing the scanned image, and emailing the scanned image. The methods also include providing a tool bar for the scanning mode screen with a plurality of icons, with each of the plurality of icons selectable to initiate an action. Selection of one of the plurality of icons initiates one of the sub steps of scanning the image, editing the scanned image, burning the scanned image onto a CD, storing the scanned image in a memory, printing the scanned image, or emailing the scanned image.

### BRIEF DESCRIPTION OF THE DRAWINGS

The invention, together with its objects and the advantages thereof, may best be understood by reference to the following description taken in conjunction with the accompanying drawings, in which like reference numerals identify like elements in the figures, and in which:

FIG. 1 is a perspective view illustrating a microfilm viewing apparatus and a viewing screen for viewing images captured by the microfilm viewing apparatus;

FIG. 2 is a perspective view illustrating microfilm viewing apparatus for remotely viewing images captured by the digital film viewer and the film access host and transmitted to a remote user's computer in accordance with the present invention;

FIGS. 3A through 3F illustrate typical screens that may be displayed on the user's computer during a remote microfilm viewing and scanning session;

FIG. 3A illustrates an initial user authorization screen;

FIG. 3B illustrates an introductory screen for the viewing and scanning session;

FIG. 3C illustrates a typical first viewing mode screen;

FIG. 3D illustrates a typical second viewing mode screen in which the remote user initiates a zoom in function;

FIG. 3E illustrates a typical viewing mode screen with the zoomed in image;

FIG. 3F illustrates a typical scanning mode screen for retrieving a desired image for editing, storing, printing or sending the image by email;

FIG. 4 illustrates the virtual camera control that appears on the remote user's screen in greater detail;

FIG. 5 illustrates the virtual film movement control that appears on the remote user's screen in greater detail; and

FIG. 6 illustrates the tool bar for the scan mode screen of FIG. 3F in greater detail.

### DESCRIPTION OF THE PREFERRED EMBODIMENTS

It will be understood that the invention may be embodied in other specific forms without departing from the spirit thereof. The present examples and embodiments, therefore, are to be considered in all respects as illustrative and not restrictive, and the invention is not to be limited to the details given herein.

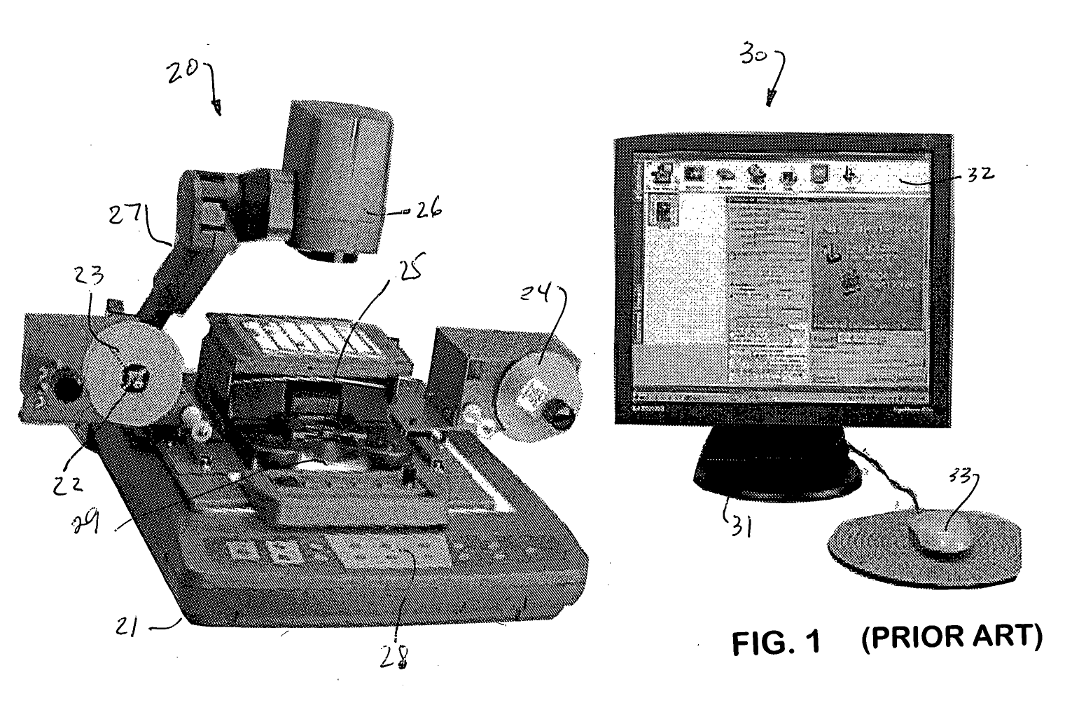

With reference to the drawing Figures, FIG. 1 illustrates a digital microfilm viewing and scanning system, generally designated 20, for digitally viewing and then scanning a microfilm medium, and a viewing device, generally designated 30, for viewing of a live video feed of an image and/or of an image scanned by viewer/scanner 20. Both viewer/scanner 20 and viewing device 30 each have a base 21 and 31, respectively, for placement of viewer/scanner 20 and viewing device 30 on a desk, table or the like. On one side of viewer/scanner 20, a roll of microfilm 23 may be mounted on a spindle 22. The microfilm on roll 23 is mounted on spindle 22 and threaded through a viewing area 25 to a take-up reel 24, which is located on the opposite side of viewer/scanner 20. The user can then move the film from one image to the next by pushing a button or by turning a knob on the take-up reel to move the film across the viewing area 25. A source of illumination 29 may be provided below the viewing area 25 to provide backlighting for viewing of the microfilm. Preferably, take-up reel 24 is motorized for fast forwarding of the microfilm and spindle 22 is also motorized for fast rewinding of the microfilm, such as when viewing is finished.

A digital camera 26 takes images of the microfilm. The digital camera is mounted to the base 21 of viewer/scanner 20 by an adjustable and extensible arm 27. A plurality of controls 28 is provided for operation of the viewer/scanner 20. For example, controls 28 may include zoom, pan, rotate, invert and focus of the film images. Digital viewer/scanner 20 is commercially available from S-T Imaging of Northfield, Ill. 60093 as model ST200. However, as presently offered, the ST200 digital viewer/scanner does not provide for viewing and scanning from a remote location, nor does the ST200 provide a virtual camera control or a virtual film movement control to facilitate viewing and scanning from a remote location.

Different embodiments of viewing devices 30 may be used with viewer/scanner 20. However, the viewing device 30 is preferably a display monitor or viewing screen of a personal computer, laptop computer, personal digital assistant, or the like, with a suitable display or viewing screen 32. Such displays 32 are commercially available from a number of vendors including Dell Inc. of Round Rock, Tex. and Hewlett-Packard Corporation of Palo Alto, Calif. Viewer/scanner 20 is preferably equipped with a connector to provide a video signal to a computer, microprocessor or the like, which in turn provides the video signal for screen 32. A mouse 33, or other suitable control device, may be used to select or control aspects of the image displayed on screen 32.

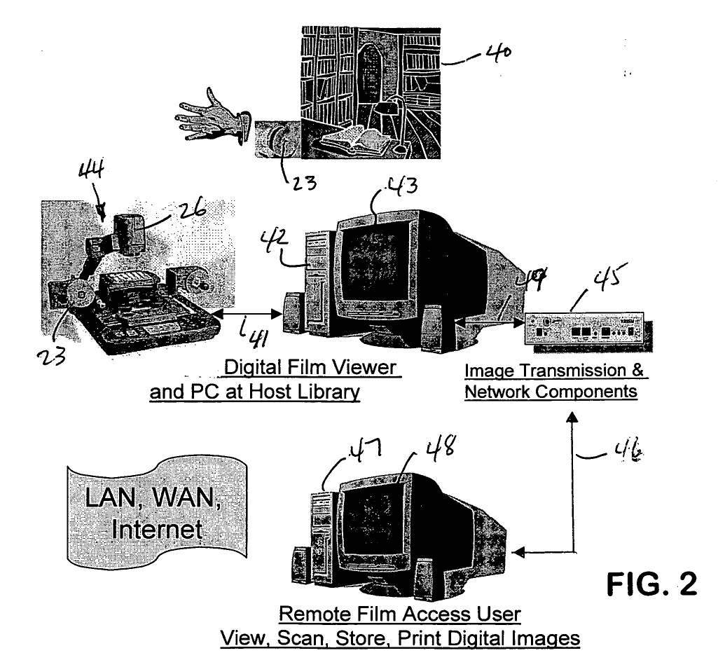

In accordance with one aspect of the present invention, and as illustrated in FIG. 2, a remote user can schedule a session to view microfilm located at a remote location, such as at a remote library 40, by communicating to the library 40 the identity of the microfilm that he/she would like to view and proposing or requesting a viewing time. This communication may be by email, telephone or any other means of communication. The library 40 will confirm a suitable time, have the microfilm 23 retrieved from its archives and loaded on the microfilm viewer/scanner 44, ready for remote viewing by the remote user. As with the digital viewer/scanner 44 and display 30 of FIG. 1, the digital viewer/scanner 20, a computer 42 and its associated display 43 reside at the location of the microfilm, which is at the library 40 in the example of FIG. 2.

It will be appreciated that the digital viewer/scanner 44 in FIG. 2 is different from the digital viewer/scanner 20 in FIG. 1. Digital viewer/scanner 20 provided a video signal from camera 26 to the display 30 for displaying the scanned image of the microfilm 23. The basic scanning controls for moving the microfilm forward and for rewinding the microfilm on the digital viewer/scanner 20 are provided at its controls 28. However, for a remote user to remotely view and then scan select images from among those viewed on the microfilm 23, it is necessary to provide virtual controls of at least these functions at the user's remote computer. Thus, a communications link 41 in FIG. 2 between the digital viewer/scanner 44 and the host computer 42 will include additional communications to implement remote microfilm advance, remote microfilm rewind and other remote film access functions that are to be remotely controlled at the user's computer 47. For example, other functions to be remotely controlled at the user's computer 47 may include rotate the image by 90, 180, 270 or 360 degrees, control brightness and contrast, zoom in and out, positive or negative image, camera focus, background lamp on or off, and color or black/white image.

Of course, host computer 42 in FIG. 2 needs to be able to translate remotely controlled functions initiated at the user's computer 47 to the digital viewer/scanner 44 to control or to obtain the desired image and image effects. To facilitate the communications between host computer 42 and remote user's computer 47, host computer 42 communicates via a communications link 49 to an image transmission and network component 45, and then via another communication link 46 to the remote user's computer. For example, communications links 46 and 49 and image transmission and network component 45 may implement a wide area network (WAN), a local area network (LAN) or an internet connection between computers 42 and 47. Of course, other means of communicating digital images and remote control functions between computers 42 and 47 may be implemented, if desired, such as a satellite communications link.

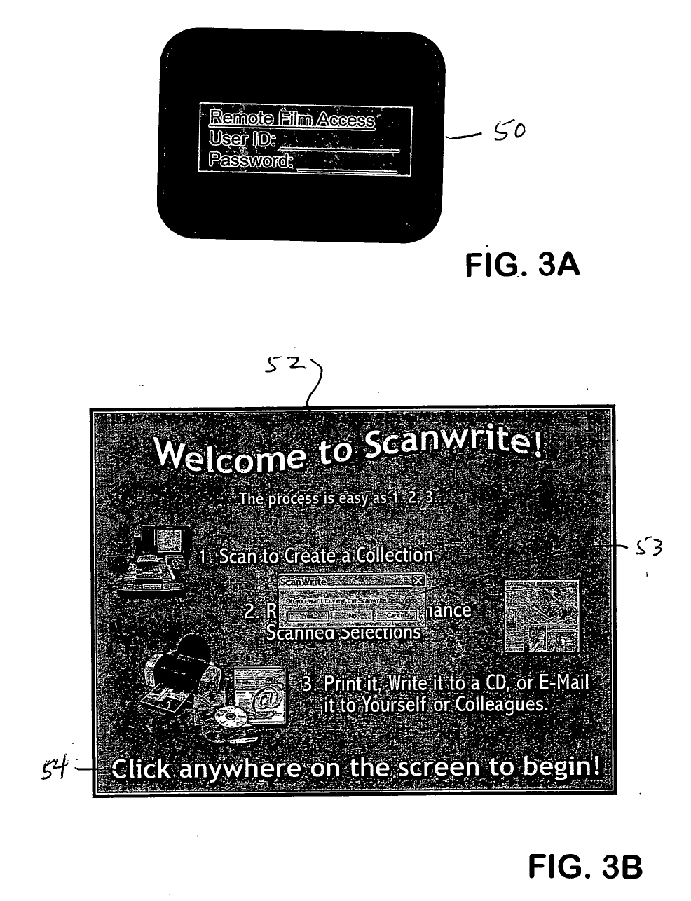

FIGS. 3A through 3F illustrate a typical set of screens that may be displayed on display 48 of user's computer 47 while remotely viewing the microfilm loaded on the digital viewer/scanner 44. In FIG. 3A, a first screen 50 may require the remote user to provide authentication or identity information, such as a user ID and a password.

The next screen 52 in FIG. 3B may be an introductory screen to advise a new user of the features of the scanning process and of the typical sequence of scanning operations. A smaller overlay 53 may invite a new user to view a help video before initiating the scanning process. As indicated by a legend 54 at the bottom of screen 52, the scanning process begins by clicking anywhere on screen 52.

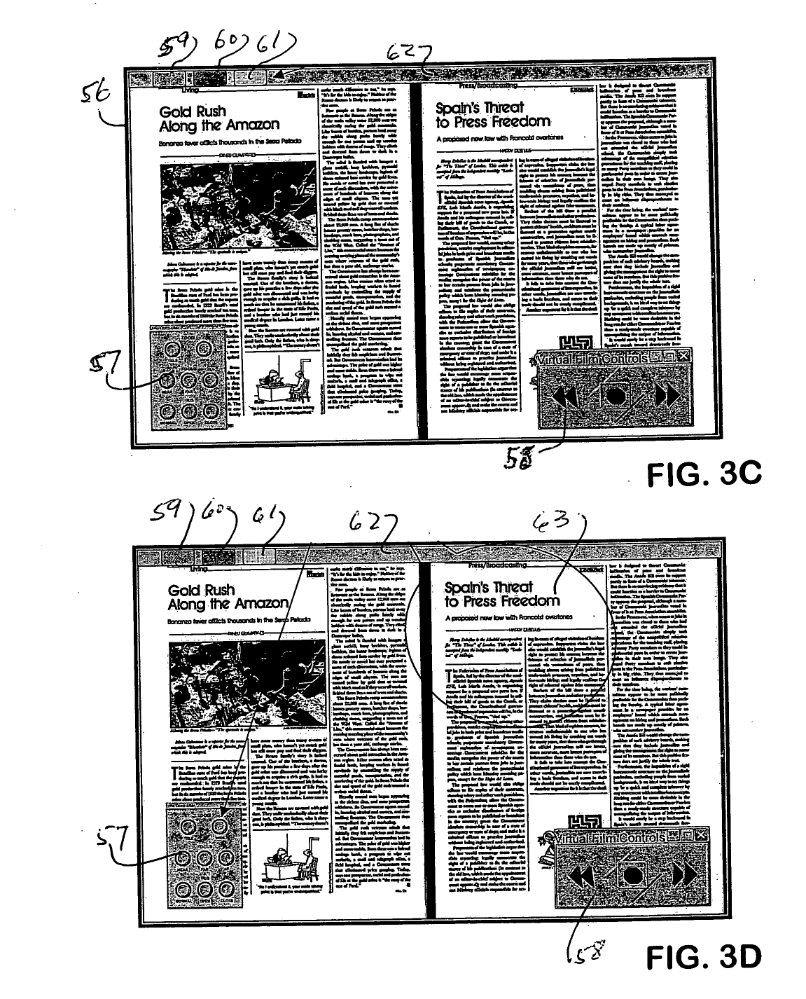

The first viewing screen 56 is shown in FIG. 3C. The camera 26 of digital viewer/scanner 44 is initially set zoomed out to show a full page. A virtual camera control 57 and a virtual film movement control 58 are turned on and are superimposed over the video representation of the image. The user can hide or minimize each of virtual controls 57 and 58, if desired. Virtual camera control 57 is shown in greater detail in FIG. 4. Virtual camera control 57 includes several individual buttons that may be actuated by the user to control various camera functions, such as telephoto zoom 81 (zoom in), wide angle zoom 82 (zoom out), near focus 83, far focus 84, auto-focus (AF) 85, normal iris 86, open iris 87 and closed iris 88.

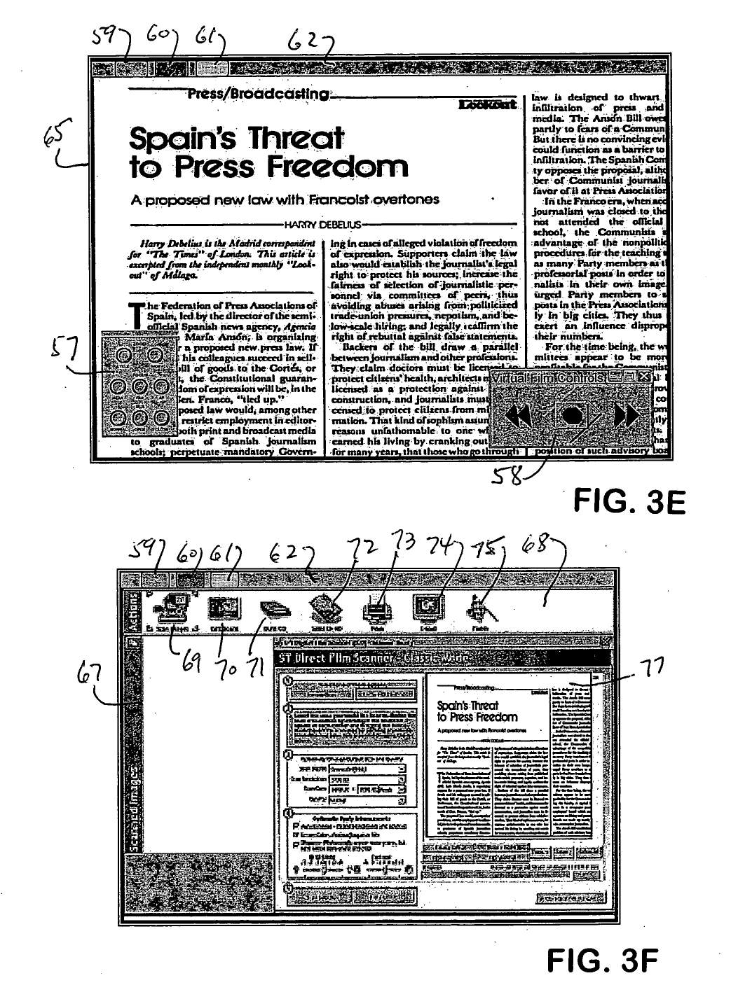

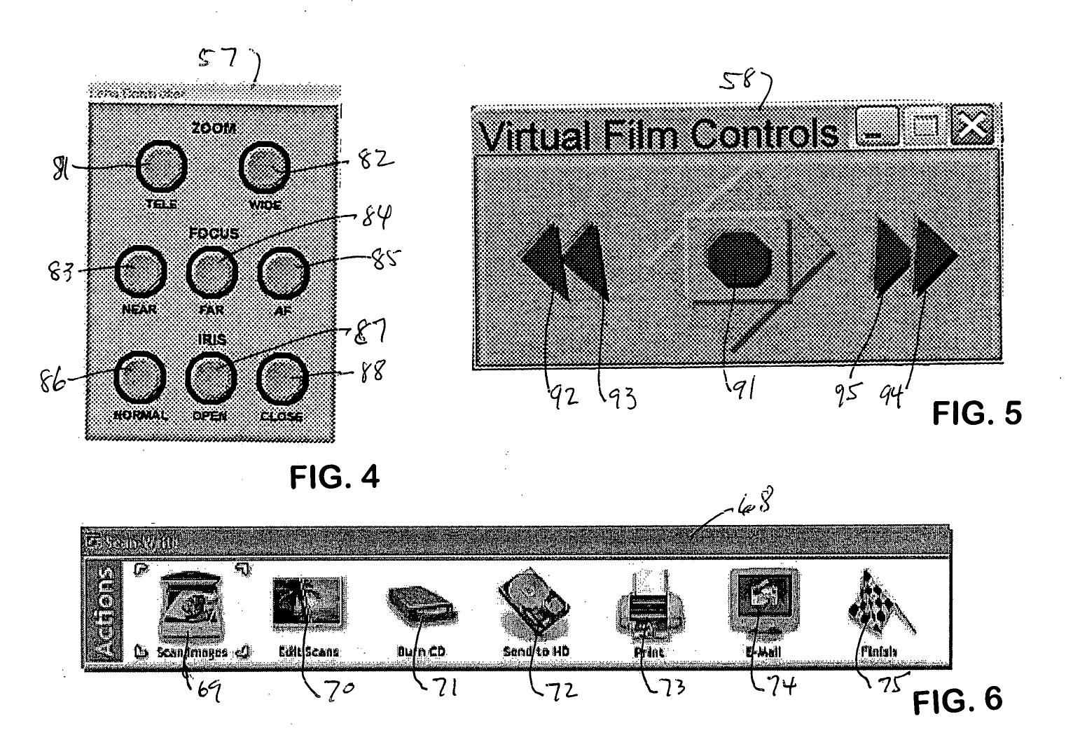

Virtual film movement control 58 controls the movement of the microfilm 23 in the digital scanner 44 and is shown in greater detail in FIG. 5. The virtual film movement control 58 includes a center stop button 91 for stopping film movement. Two left pointing arrows provide for reverse film movement, including a first left pointing arrow 92 for fast reverse (rewind) film movement and a second left pointing arrow 93 for slow reverse film movement. Two right pointing arrows provide for forward film movement, including a first right pointing arrow 94 for fast forward film movement and a second right pointing arrow 95 for slow forward film movement. A tool bar 62 is located at the top of screen 56. It may include tool bar buttons 59-61 for selecting modes of operation or functions such as hide/show controls, view mode/scan mode, log out, session time and/or capture snapshot of image. Tool bar 62 is shown in greater detail in FIG. 6.

In FIG. 3D, the user decides that he/she want to zoom in on the right-hand page 63. By using the telephoto function on the virtual camera control 57, the user can zoom in to obtain an enlarged view of page 63, which is shown in FIG. 4E in viewing screen 65. When the user decides that an image is of sufficient interest that the user wants to capture the image, he/she uses one of the buttons 59-61 to in the tool bar 62 to switch to the scan mode.

A typical scan mode screen 67 is shown in FIG. 3F. A portion 77 of screen 67 displays the selected image. Another tool bar 68, disposed below tool bar 62, provides a set of action icons 69-75 that the user may select. Tool bar 68 is shown in greater detail in FIG. 6. For example, the user may select icon 69 in tool bar 68 to scan an image, icon 70 to edit a scanned image, icon 71 to burn the scanned image on a CD, icon 72 to store the scanned image on the hard drive of computer 48, icon 73 to print the scanned image on a printer, icon 74 to attach the scanned image to an email sent to another person or to the user's email, and icon 75 to finish or terminate the scanning session.

S-T Imaging also sells a MOCA attachment (not shown) for the ST200 viewing and scanning system that provides additional viewing and capture of microfiche and opaque microprint media with the ST200 digital viewer/scanner. This MOCA attachment is manually operated and does not have provision for remotely controlling the viewing and scanning functions. However, if desired, this MOCA attachment could be similarly provided with automated controls and with a virtual microfiche movement control, which may be similar to the virtual film movement control 58 for microfilm shown in FIG. 5. The viewing and scanning system 20 would then also be able to view and scan microfiche and opaque microprint media from a remote location in a manner similar to the foregoing description of remotely viewing and scanning microfilm.

While particular embodiments of the invention have been shown and described, it will be obvious to those skilled in the art that changes and modifications may be made therein without departing from the invention in its broader aspects.

1. Apparatus for remotely viewing and scanning microfilm at a first location, while controlling the viewing and scanning from a remote location, said apparatus comprising:
a viewing and scanning device for viewing and scanning microfilm at the first location, said viewing and scanning device generating a video feed of images prior to scanning and scanned images of the microfilm after scanning;
a host computer at the first location, said host computer in communication with the viewing and scanning device to receive the video feed and the scanned images;
a user's computer at a remote location from the first location, said user's computer in communication with said host computer to receive the video feed and the scanned images from the host computer; and
a virtual film movement control at the user's computer to enable a user at the remote location to control the movement of the microfilm at the first location.

2. The apparatus for remotely viewing and scanning microfilm in accordance with claim 1, wherein said virtual film movement control includes at least one control function from the group consisting of forward film movement, fast forward film movement, reverse film movement, fast reverse film movement and stop film movement.

3. The apparatus for remotely viewing and scanning microfilm in accordance with claim 1, said apparatus further comprising:
a virtual camera control at the remote location for controlling a camera of the viewing and scanning device that generates the images.

4. The apparatus for remotely viewing and scanning microfilm in accordance with claim 3, wherein said virtual camera control includes at least one control function from the group consisting of zoom in, zoom out, near focus, far focus, auto-focus, iris normal, iris open and iris closed.

5. The apparatus for remotely viewing and scanning microfilm in accordance with claim 1, wherein said user's computer is provided with a viewing mode screen for reviewing and selecting a scanned image.

6. The apparatus for remotely viewing and scanning microfilm in accordance with claim 1, wherein said user's computer is provided with a viewing and scanning mode screen for acting upon a selected image, including actions selected from the group consisting of editing the scanned image, burning the scanned image onto a CD, sending the scanned image to a memory for storage, printing the scanned image and emailing the scanned image.

7. The apparatus for remotely viewing and scanning microfilm in accordance with claim 6, wherein said scanning mode screen includes a tool bar with a plurality of icons.

8. The apparatus for remotely viewing and scanning microfilm in accordance with claim 7, wherein said plurality of icons includes one icon for each of those actions selected from the group consisting of editing the scanned image, burning the scanned image onto a CD, sending the scanned image to a memory for storage, printing the scanned image and emailing the scanned image.

9. A method of viewing and scanning microfilm at a first location from a remote location comprising the steps of:
generating a video feed of images prior to scanning and scanned images of the microfilm after scanning at the first location;
communicating the video feed and the scanned images from the first location to the remote location; and
providing a virtual film movement control at the remote location to enable a user at the remote location to control the movement of the microfilm at the first location.

10. The method of viewing and scanning microfilm in accordance with claim 9 wherein the step of providing a virtual film movement control includes one or more of the following sub steps:
forward film movement;
fast forward film movement;
reverse film movement;
fast reverse film movement; and
stop film movement.

11. The method of viewing and scanning microfilm in accordance with claim 9 further comprising the step of:
providing a virtual camera control at the remote location for controlling a camera at the first location that generates the images.

12. The method of viewing and scanning microfilm in accordance with claim 11 wherein the step of providing a virtual camera control includes one or more of the following sub steps:
zoom in;
zoom out;
near focus;
far focus;
auto-focus;
iris normal;
iris open; and
iris closed.

13. The method of viewing and scanning microfilm in accordance with claim 9 further comprising the step of:
providing a viewing mode screen for reviewing and selecting an image to be scanned.

14. The method of viewing and scanning microfilm in accordance with claim 9 further comprising the step of:
providing a scanning mode screen for acting upon a selected image.

15. The method of viewing and scanning microfilm in accordance with claim 14 wherein the step of acting upon a selected image includes one or more of the following sub steps:
editing the scanned image;
burning the scanned image onto a CD;
sending the scanned image to a memory for storage;
printing the scanned image; and
emailing the scanned image.

16. The method of viewing and scanning microfilm in accordance with claim 14 further comprising the step of:
providing a tool bar with a plurality of icons; each of the plurality of icons selectable to initiate an action.

17. The method of viewing and scanning microfilm in accordance with claim 16 wherein selection of one of the plurality of icons initiates one of the following sub steps:
scanning the image;
editing the scanned image;
burning the scanned image onto a CD;
storing the scanned image in a memory;
printing the scanned image; or
emailing the scanned image.
